(19) United States
(12) Patent Application Publication
(10) Pub. No.: US 2006/0249644 A1
(43) Pub. Date: Nov. 9, 2006

(54) Screw adjustment mechanism, slider comprising such an adjustment mechanism and seat comprising such a slider

(75) Inventors: Dominique Folliot, Flers (FR); Sylvain Desquesne, Conde Sur Noireau (FR)

Correspondence Address: MILLER, MATTHIS & HULL, ONE NORTH FRANKLIN STREET, SUITE 2350, CHICAGO, IL, 60606, US

(73) Assignee: Faurecia Sieges d'Automobile, Nanterre (FR)

(21) Appl. No.: 11/372,482

(22) Filed: Mar. 9, 2006

(30) Foreign Application Priority Data
Mar. 14, 2005 (FR) FR 05 02489

(51) Int. Cl. F16M 13/00

(52) U.S. Cl. 248/429

(57) ABSTRACT

Screw adjustment mechanism, comprising a screw and a nut screwed onto the said screw, the nut being mounted rotatably in a casing furnished with a transverse wall traversed by the screw. A plastic bearing is fitted into the transverse wall and interposed without clearance between the screw and the transverse wall.

The present invention relates to screw adjustment mechanisms, sliders comprising such mechanisms and seats comprising such sliders.

More particularly, the invention relates to a screw adjustment mechanism comprising a screw which extends in a longitudinal direction and a nut screwed onto the said screw, the nut being mounted rotatably in a casing, the said mechanism comprising at least one plastic bearing that is attached to the casing and that surrounds the screw substantially without clearance, the casing comprising at least one transverse wall substantially perpendicular to the longitudinal direction and having an opening traversed by the screw.

Document US-A-2005/0035261 describes an example of such an adjustment mechanism which has the disadvantage that, under the effect of an axial force exerted between the screw and the nut, the nut and the casing can pivot, moving out of alignment with the screw, which causes increased friction between the nut and the screw, whence:
screeching or other noises when the mechanism operates,
a risk of premature wear of this mechanism,
additional stresses imposed concerning the manufacturing tolerances of the elements forming the mechanism,
and, where appropriate, a risk of this mechanism seizing up.

A particular objective of the present invention is to alleviate some or all of these disadvantages.

To this end, according to the invention, an adjustment mechanism of the type in question is characterized in that the bearing is fitted into the said opening and interposed between the screw and the said transverse wall.

These arrangements prevent or at least limit the ability of the nut and the casing to move out of alignment with the screw under stress, thus preventing or limiting the abovementioned disadvantages.

In preferred embodiments of the invention, it may be necessary to also make use of one and/or other of the following arrangements:
the bearing comprises a flange protruding radially outwards that is interposed, in the longitudinal direction, between the nut and the transverse wall of the casing;
the flange interacts with the casing to stop the bearing rotating relative to the casing;
the bearing also comprises a collar protruding radially outwards, on a side of the transverse wall oriented away from the nut;
the collar is fitted into an opening made in an elastomer transverse wall that is fixedly attached to the casing and that covers the transverse wall of the casing on the opposite side from the nut;
the elastomer transverse wall also comprises at least one additional opening into which at least one abutment is fitted belonging to the transverse wall of the casing;
the elastomer transverse wall also comprises two additional openings into which are fitted two abutments belonging to the transverse wall of the casing and aligned in a first transverse direction perpendicular to the longitudinal direction, these two abutments being offset relative to the screw in a second transverse direction perpendicular to the longitudinal direction and perpendicular to the first transverse direction;
the collar has a substantially rectilinear edge disposed on the opposite side of the abutments from the screw, this rectilinear edge delimiting two corner zones;
the casing is held by a support device which has a first transverse flange extending parallel to the transverse wall of the casing, the elastomer transverse wall being interposed between the said transverse wall of the casing and the said first transverse flange, the said first transverse flange comprising an opening traversed with clearance by the screw, the said abutments and the said collar being adapted to press substantially simultaneously against the said first transverse flange when the elastomer transverse wall is sufficiently compressed as a consequence of a force exerted between the nut and the screw in the longitudinal direction;
the bearing comprises a cylindrical end that is engaged in a cylindrical housing belonging to the nut;
the mechanism comprises an additional plastic bearing fixedly attached to the casing and traversed substantially without clearance by the screw, the nut being surrounded by the said bearing and the said additional bearing.

Furthermore, the invention also has as its subject a slider comprising a first slider element mounted so as to slide relative to a second slider element in the said longitudinal direction, the said slider comprising an adjustment mechanism as defined above whose casing is attached to the first slider element and the screw is fixedly attached to the second slider element. The casing may be attached to the first slider element by means of the said support device. The support device may also comprise a second transverse flange parallel to the first transverse flange, the casing being disposed between the said first and second transverse flanges, an additional elastomer transverse wall being interposed between the casing and the second transverse flange.

Finally, a further subject of the invention is a vehicle seat comprising a squab supported by at least one slider as defined hereinabove.

Other features and advantages of the invention will appear during the following description of two of its embodiments, given as non-limiting examples with reference to the attached drawings.

In the drawings:

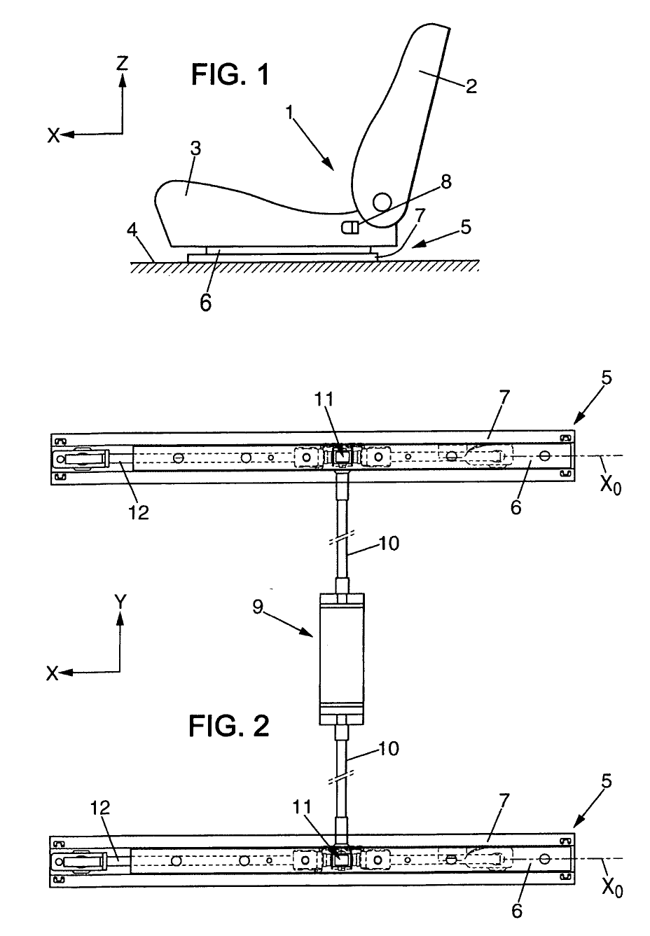

FIG. 1 is a schematic view of a seat that can include sliders according to a first embodiment of the invention,

FIG. 2 is a top view of the sliders of the seat of FIG. 1,

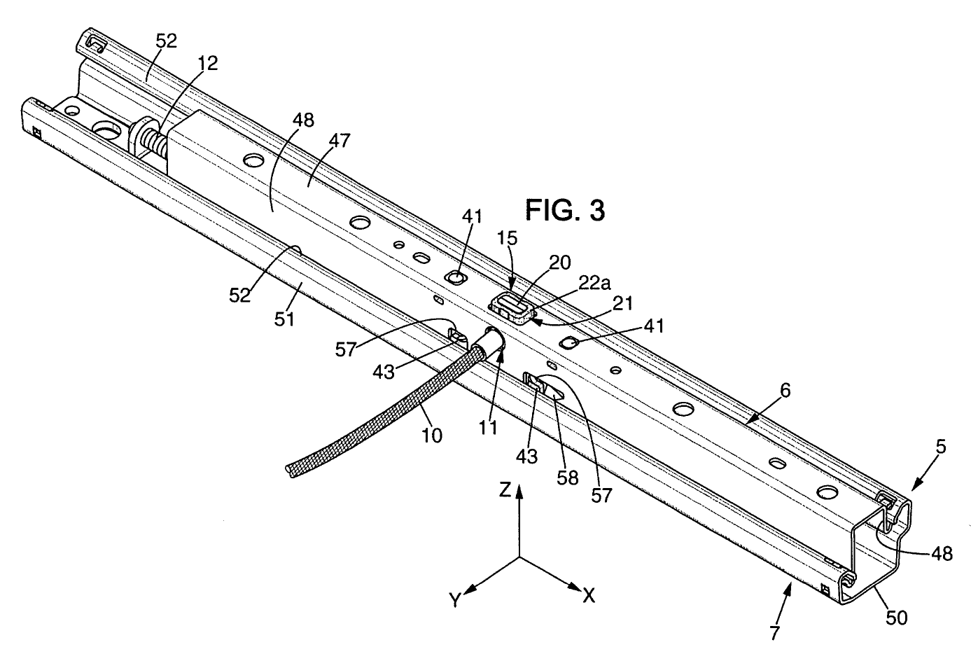

FIG. 3 is a view in perspective of one of the sliders of FIG. 2,

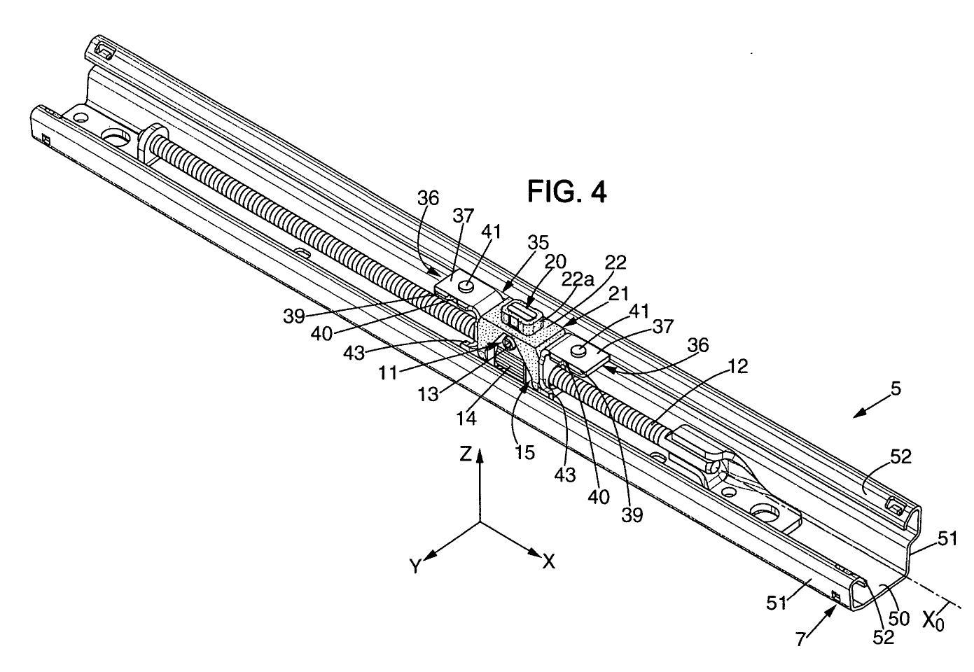

FIG. 4 is a view similar to FIG. 3 showing the slider without the first slider element,

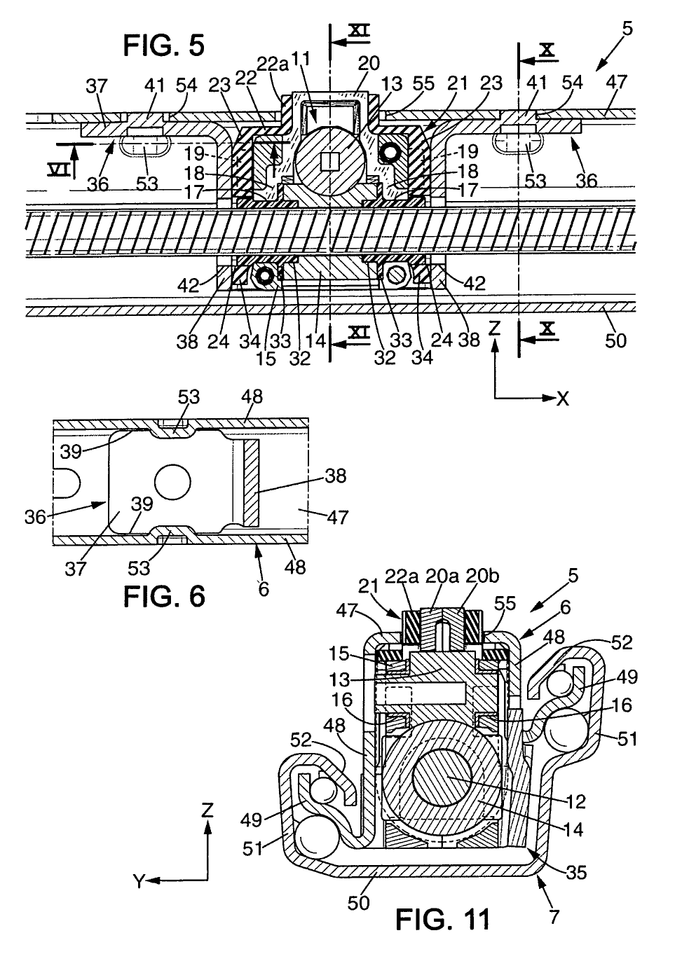

FIG. 5 is a view in longitudinal section of a part of the slider of FIG. 3,

FIG. 6 is a partial view in section along the line VI-VI of FIG. 5,

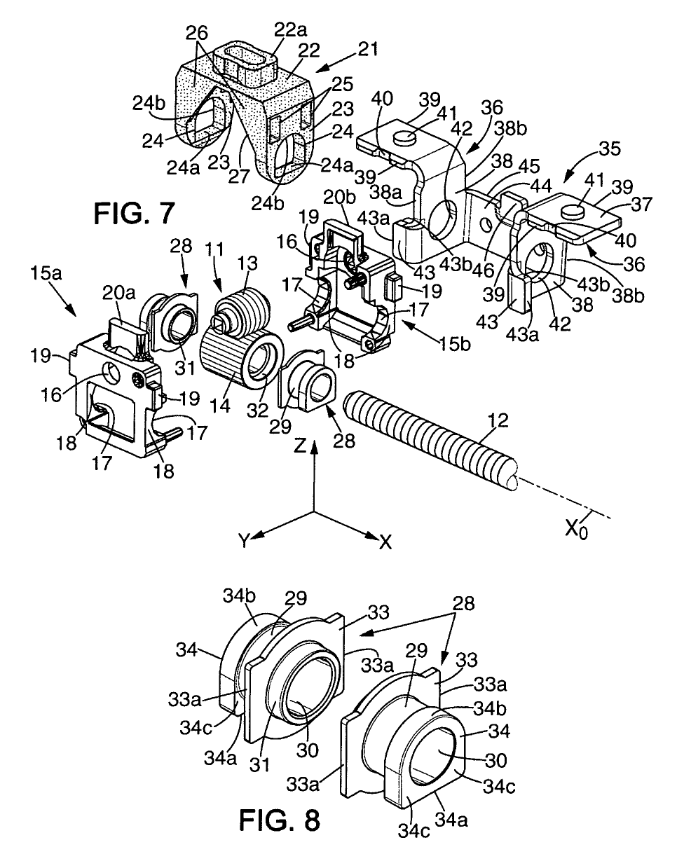

FIG. 7 is an exploded view showing the screw-nut assembly of the slider of FIGS. 3 to 5, with the support of this screw-nut assembly,

FIG. 8 is a detail view of two bearings belonging to the screw-nut assembly of FIG. 7,

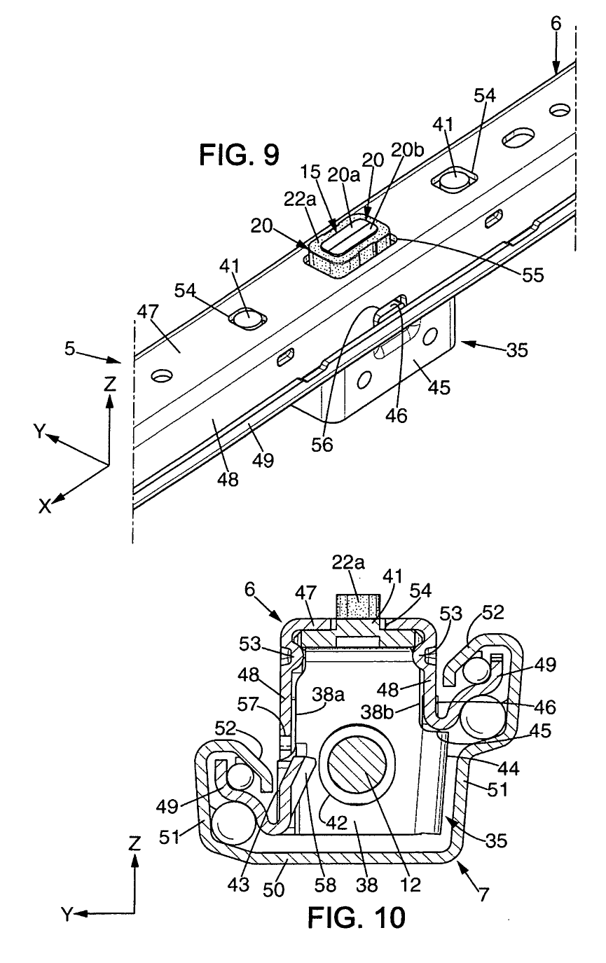

FIG. 9 is a view in perspective showing the first element of the slider of FIG. 3 with the screw-nut assembly and its support,

FIGS. 10 and 11 are views in section respectively along the lines X-X and XI-XI of FIG. 5,

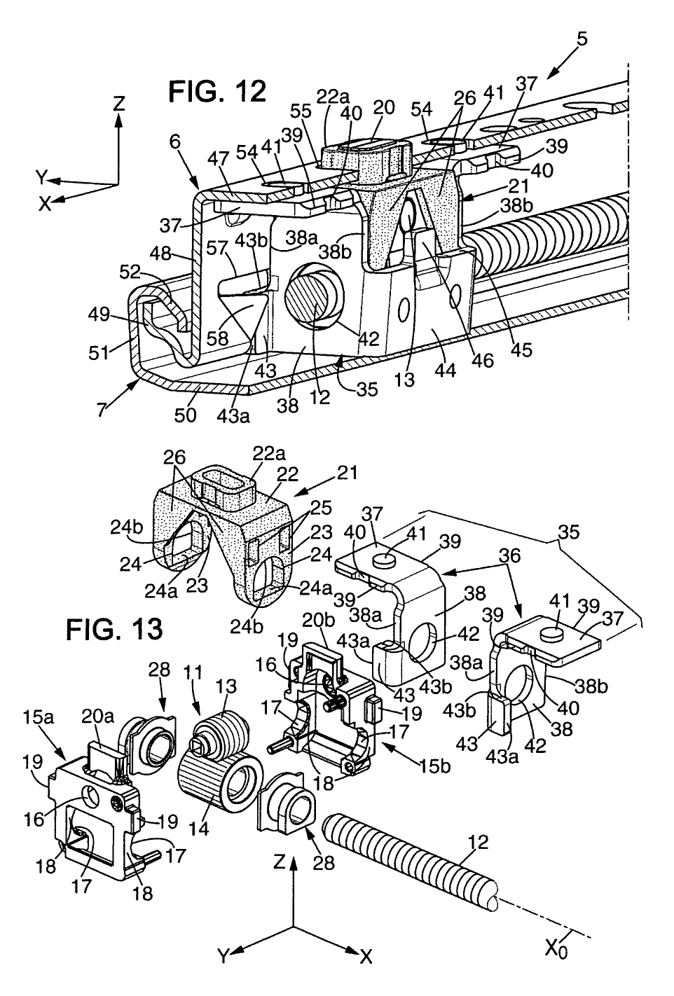

FIG. 12 is a cut-away view in perspective of the slider of FIG. 3,

FIG. 13 is a view similar to FIG. 7, in a second embodiment of the invention,

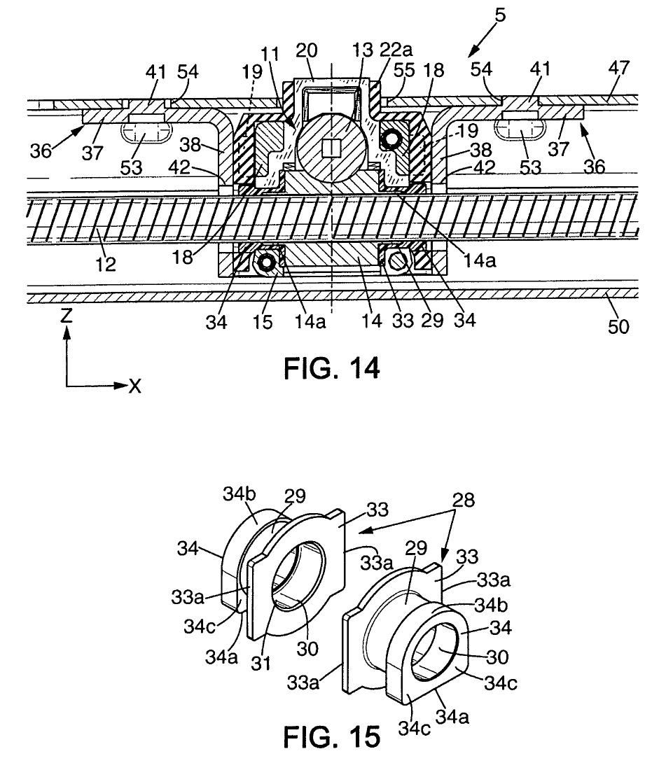

FIG. 14 is a view in longitudinal section similar to FIG. 5, in a second embodiment of the invention,

and FIG. 15 is a view similar to FIG. 8, for the second embodiment of the invention.

In the various figures, the same reference numbers indicate identical or similar elements.

FIG. 1 represents a motor vehicle seat 1 which comprises a back 2 supported by a squab 3 itself mounted slidingly on the floor 4 of the vehicle in a substantially horizontal longitudinal direction X.

The squab 3 is connected to the floor 4 by two parallel sliders 5, clearly visible in FIG. 2. Each of these sliders comprises first and second slider elements 6, 7, respectively connected to the squab 3 and to the floor 4, which slide on one another in the direction X.

The adjustment of the sliders 5 is motorized, and controlled for example by means of a button 8 which controls the operation of an electric motor 9, visible in FIG. 2, attached for example to the structure of the squab 3. The electric motor 9 rotates for example two Bowden cables 10 (FIGS. 2 and 3) whose ends themselves operate two reduction gears 11 supported by the first elements 6 of the two sliders 5.

The reduction gears 11 each rotate a nut 14 that is also supported by the first element 6 of each slider, which nut is screwed onto a screw 12 fixedly attached to the second element 7 of each slider. Each screw 12 extends along a central axis X0 parallel to the longitudinal direction X, and the nut 14 is mounted rotatably about the central axis X0 of the screw 12.

As shown in FIGS. 4, 5, 7 and 11, the reduction gear 11 may comprise a worm wheel 13 and an external tooth gear of the nut 14, the worm wheel 13 being engaged with the said external tooth gear. The worm wheel 13 is mounted rotatably about an axis of rotation parallel to a transverse direction Y substantially horizontal and perpendicular to the longitudinal direction X.

As shown in greater detail in FIG. 7, the worm wheel 13 and the nut 14 are contained in a casing 15 that may be made for example in two parts moulded in light alloy 15a, 15b each forming substantially one half of the casing 15, the two parts 15a, 15b of the casing being separated from one another by a vertical mid-plane (X, Z), where Z is a vertical direction perpendicular to the abovementioned directions X, Y.

Each of the parts 15a, 15b of the casing may comprise a bore 16 in which the worm wheel 13 swivels (FIGS. 7 and 11), and the casing 15 also delimits two circular openings 17 centred on the axis X0 for the screw 12 to pass through (FIGS. 5 and 7), each of the openings 17 being made in a transverse wall 18 of the casing which extends parallel to the plane (Y, Z) . The transverse walls 18 are disposed axially either side of the nut 14 and the said transverse walls 18, like the openings 17, are each formed for half in the two parts 15a, 15b of the casing.

The casing 15 may also comprise abutments 19 protruding axially in the longitudinal direction X, in two opposite directions, from the transverse walls 18. In the example shown in the drawings, the abutments 19 are four in number and are formed for half on each of the parts 15a, 15b of the casing.

In addition, the casing 15 may also comprise a head 20 protruding upwards, this head 20 being able for example to be formed in two halves 20a, 20b belonging respectively to the two parts 15a, 15b of the casing.

The casing 15 may be covered externally, at least partially, by an elastomer jacket 21, clearly visible in FIGS. 4, 5 and 7. This elastomer jacket may comprise for example a substantially horizontal top wall 22 which covers the casing 15 towards the top, this top wall 22 being itself extended upwards in its centre by a funnel 23 traversed by the protruding head 20 of the casing.

The jacket 21 also comprises two transverse walls 24 which extend parallel to the plane (Y, Z) and surround the transverse walls 18 of the casing. Each of the transverse walls 24 of the jacket 21 is traversed by:
an opening 24a opposite the corresponding opening 17 of the casing, for the screw 12 to pass through, the opening 24 being able to be, for example, delimited towards the bottom by a flat horizontal face 24a and towards the top by an arch 24b,
and two openings 25 into which are fitted the corresponding abutments 19.

Finally, in the example shown in the drawings, the elastomer jacket 21 also comprises side walls 26 parallel to the plane (X, Z), which connect the lateral edges of each transverse wall 23 to the lateral edges of the top wall 22. These side walls 26 each have a central, substantially V-shaped recess 27, open towards the bottom, in particular allowing the abovementioned Bowden cables 10 to pass through.

Furthermore, as can be seen in detail in FIGS. 5, 7 and 8, the screw-nut assembly 12, 14 of each slider also comprises two identical or similar bearings 28, made of plastic, for example of polyamide 6-6, where appropriate reinforced by glass or other fibres.

The bearings 28 are fixedly attached to the casing 15 and disposed either side of the nut 14, and the said bearings 28 are traversed by the screw 12 substantially without radial clearance. Each bearing 28 has an axial length, in the longitudinal direction X, at least equal to two to three times the pitch of the screw 12, even a markedly greater length as in the example shown here.

Each bearing 28 has a cylindrical tubular wall 29 which delimits a central bore 30 and which is fitted without clearance into one of the circular openings 17 of the casing 15. The tubular wall 29 may comprise an inner end 31 which penetrates a cylindrical housing 32 made at the corresponding axial end of the nut 14.

The tubular wall 29 also comprises an outer flange 33 that is inserted axially, in the longitudinal direction X, between the nut 14 and the corresponding transverse wall 20, substantially without clearance. The flange 33 has an external shape (comprising in particular rectilinear opposite vertical edges 33a) suitable for interacting with the casing 15 in order to stop the bearing 28 rotating about the axis X0.

Finally, each bearing 28 may comprise an outer collar 34 which extends radially outwards from the external end of the bearing 28. The collar 34 is disposed against the outer face of the corresponding transverse wall 20 of the casing, and it is engaged in the corresponding opening 24 of the elastomer jacket 21. The collar 34 advantageously has an external shape substantially identical to the shape of the opening 24 with a bottom edge 34a that is substantially rectilinear and horizontal and a top edge 34b substantially arch-shaped that joins the two ends of the bottom edge 34a forming two corners 34c.

As can be seen in FIG. 5, when no force is applied to the screw-nut assembly 12, 14, the transverse walls 23 of the elastomer jacket have a thickness that is slightly greater than the thickness of the collar 34 and of the abutments 19 in the longitudinal direction X, the collar 34 furthermore having substantially the same thickness as the abutments 19 in this direction.

As shown in FIGS. 5, 7, 10, 11, 12, the casing 15 is mounted in the slider 5 by means of a support device 35 which can be made, for example, of bent and punched metal sheet. The support device 35 comprises first and second brackets 36 which each include a substantially horizontal lug 37 which extends in the plane (X, Y) and a transverse flange 38 which extends the horizontal lug 37 substantially at 90 degrees downwards and which extends parallel to the plane (X, Z).

The horizontal lugs 37 extend away from one another, and each comprises two longitudinal edges 39 that may, where appropriate, be bevelled. Each longitudinal edge 39 may comprise at least one indentation 40 whose use will be seen later. Each horizontal lug 37 may also comprise a post 41, made for example by half-punching (fine stamping), which protrudes upwards.

Each transverse flange 38 furthermore has a circular opening 42 which is traversed with clearance by the screw 12.

Each transverse flange 38 may, where appropriate, be extended, over a part of its height, by a bottom rebate 43 which extends parallel to the plane (X, Z) from one of the vertical side edges 38a of the said transverse flange. The rebates 43 extend away from one another to a vertical front edge 43a, while also delimiting a top horizontal edge 43b. The rebates 43 are slightly offset laterally towards the outside of the slider relative to the vertical edges 38a of the transverse flanges 38.

Furthermore, the other vertical edge 38b of each transverse flange 38 is extended by a connecting wall 44 which extends parallel to the longitudinal direction X and substantially vertically (or slightly obliquely relative to the vertical direction Z, as in the example shown) connecting the bottom parts of the edges 38b of the transverse flanges 38. The connecting wall 44 is slightly offset laterally towards the outside relative to the transverse walls 38, and it delimits a top edge 45 that can be extended locally upwards by a rigid protruding tab 46, this tab 46 being able, where appropriate, to be slightly offset laterally inwards from the connecting wall 44.

As can be seen in FIG. 10, the first slider element 6 has a substantially U-shaped cross section with a substantially horizontal top web 47, parallel to the plane (X, Y), and two side flanges 48 which extend downwards from the top web 47. Each side flange 48 extends to a bottom end that is extended, obliquely outwards and upwards, by a rebate 49. The bottom end of one of the side flanges 48 is situated closer to the bottom 50 of the second slider element than the other.

The second slider element, for its part, also has a substantially U shape which includes the substantially horizontal bottom 50, parallel to the directions X, Y and two side flanges 51 which surround the side flanges 48 of the first slider element and are extended by re-entrant troughs 52 which take in respectively the rebates 49.

The support device 35 is attached to the first slider element 6 by crimping of the said first slider element onto the said support device 35, which limits the number of parts of the slider 5 and markedly simplifies its manufacturing process.

More particularly, as can be seen in particular in FIGS. 5, 6 and 10, the side flanges 48 of the first slider element 6 are crimped onto the longitudinal edges 39 of the horizontal lugs 37 of the said support device. This crimping may be obtained by means of punchings 53 that are made locally facing each indentation 40. Each punching 53 protrudes towards the inside of the slider 5 penetrating into the corresponding indentation 40 and under the horizontal lug 37. The punchings 53 thus hold the lugs 37 against the bottom face of the web 47 of the first slider element, while immobilizing the said lugs 37 relative to the first slider element 6 in all the directions X, Y and Z at once.

The post 41 of each horizontal lug 37 is furthermore fitted into a recess 54 made in the web 47 of the first slider element (FIGS. 5, 9, 10, 12), which further helps to immobilize the support 35 relative to the first slider element in the direction X.

It will also be noted that the head 20 of the casing and the funnel 23 of the elastomer jacket pass through an opening 55 made in the web 47 of the first slider element.

Furthermore, the immobilization of the support 35 relative to the first slider element in the direction X is further improved by the fact that the tongue 46 penetrates into a window 56 cut out of the shortest side flange 48 of the first slider element (FIGS. 9, 10, 11), this window 56 opening downwards from the bottom end of this side flange 48.

The top edge 45 of the connecting wall 44 is also adapted to butt against the bottom end of the said shortest side flange 48, which also helps to immobilize the support 35 relative to the first slider element in the direction Z.

Finally, the rebate 43 of each transverse flange penetrates an opening 57 made in the corresponding side flange 48 of the first slider element. Thus, the top edge 43b of the rebate is suitable for butting against the corresponding side flange 48 towards the top when the slider is subjected to a considerable force. The front edge 43a of the rebate 43 is suitable for butting in the longitudinal direction X against the said side flange 48. In particular, the opening 57 which receives the rebate 43 oriented towards the front of the seat 1, comprises a cleft 58 which protrudes towards the inside of the first slider element 6, and the front edge 43a of this rebate is suitable for butting against the said cleft 58 in the longitudinal direction X towards the front of the seat, which provides an especially effective abutment.

Furthermore, during operation of the screw-nut assembly 12, 14, the abutments 19 limit the transverse walls 18 of the elastomer jacket being crushed against the transverse flanges 38. These abutments 19 also protect the bearings 28 against axial crushing under the effect of an excessive axial force in the longitudinal direction X. The collars 34 of these bearings, and in particular the corners 34c formed by these collars, also participate in withstanding these axial forces, because of the head-on abutment achieved by these collars 34 against the inner face of each transverse flange 38.

In addition, and above all, the bearings 38 hold the nut 14 aligned and centred on the axis X0 during operation of the screw-nut assembly, which prevents the screeching or grinding noises during this operation and which also limits the wear on the screw 12 and the nut 14. It will be noted that the sliding of the bearings 28 on the screw 12 does not generate noise or noticeable wear of the bearings 28, due mainly to the fact that the screw 12 is fixed.

The second embodiment, shown in FIGS. 13 to 15, is similar to the first embodiment and will therefore not be described again in detail. This second embodiment differs from the first embodiment in the following points:
the support device 35 is made of two pieces 36, the connecting wall 44 being deleted,
the bearings 28 comprise no protruding part 31 fitted into the nut 14, and the said nut 14 comprises no corresponding housings 32; on the contrary, the nut 14 may, where necessary, have two protruding parts 14a which penetrate respectively into the bores 30 of the bearings 28.

1. Screw adjustment mechanism, comprising a screw which extends in a longitudinal direction and a nut screwed onto the said screw, the nut being mounted rotatably in a casing, the said mechanism comprising at least one plastic bearing that is attached to the casing and that surrounds the screw substantially without clearance, the casing comprising at least one transverse wall substantially perpendicular to the longitudinal direction and having an opening traversed by the screw,
characterized in that the bearing is fitted into the said opening and interposed between the screw and the said transverse wall.

2. Adjustment mechanism according to claim 1, in which the bearing comprises a flange protruding radially outwards that is interposed, in the longitudinal direction, between the nut and the transverse wall of the casing.

3. Adjustment mechanism according to claim 2, in which the flange interacts with the casing to stop the bearing rotating relative to the casing.

4. Adjustment mechanism according to claim 1, in which the bearing also comprises a collar protruding radially outwards, on a side of the transverse wall oriented away from the nut.

5. Adjustment mechanism according to claim 4, in which the collar is fitted into an opening made in an elastomer transverse wall that is fixedly attached to the casing and that covers the transverse wall of the casing on the opposite side from the nut.

6. Adjustment mechanism according to claim 5, in which the elastomer transverse wall also comprises at least one additional opening into which at least one abutment is fitted belonging to the transverse wall of the casing, the collar and the abutment having a lesser thickness than the elastomer transverse wall in the longitudinal direction.

7. Adjustment mechanism according to claim 5, in which the elastomer transverse wall comprises two additional openings into which are fitted two abutments belonging to the transverse wall of the casing and aligned in a first transverse direction perpendicular to the longitudinal direction, these two abutments being offset relative to the screw in a second transverse direction perpendicular to the longitudinal direction and perpendicular to the first transverse direction, the collar and the abutments having a lesser thickness than the elastomer transverse wall in the longitudinal direction.

8. Adjustment mechanism according to claim 7, in which the collar has a substantially rectilinear edge disposed on the opposite side of the or each abutment from the screw, this rectilinear edge delimiting two corner zones.

9. Adjustment mechanism according to claim 7, in which the casing is held by a support device which has a first transverse flange extending parallel to the transverse wall of the casing, the elastomer transverse wall being interposed between the said transverse wall of the casing and the said first transverse flange, the said first transverse flange comprising an opening traversed with clearance by the screw, the said abutments and the said collar being adapted to press substantially simultaneously against the said first transverse flange when the elastomer transverse wall is sufficiently compressed as a consequence of a force exerted between the nut and the screw in the longitudinal direction.

10. Adjustment mechanism according to claim 1, in which the bearing comprises a cylindrical end that is engaged in a cylindrical housing belonging to the nut.

11. Adjustment mechanism according to claim 1, comprising an additional plastic bearing fixedly attached to the casing and traversed substantially without clearance by the screw, the nut being surrounded by the said bearing and the said additional bearing.

12. Slider comprising a first slider element mounted so as to slide relative to a second slider element in the said longitudinal direction, the said slider comprising an adjustment mechanism according to claim 1, whose casing is attached to the first slider element and the screw is fixedly attached to the second slider element.

13. Slider according to claim 12, comprising an adjustment mechanism according to claim 10, in which the casing is attached to the first slider element by means of the said support device.

14. Slider according to claim 13, in which the support device also comprises a second transverse flange parallel to the first transverse flange, the casing being disposed between the said first and second transverse flanges, an additional elastomer transverse wall being interposed between the casing and the second transverse flange.

15. Vehicle seat comprising a squab supported by at least one slider according to claim 12.
